(19) United States
(12) Patent Application Publication
(10) Pub. No.: US 2010/0171041 A1
(43) Pub. Date: Jul. 8, 2010

(54) TOMOGRAPH, TOMOGRAPHY, TOMOGRAPHY PROGRAM, AND COMPUTER-READABLE RECORDING MEDIUM WHERE THE PROGRAM IS RECORDED

(75) Inventor: Hidehiro Iida, Osaka (JP)

Correspondence Address: GRIFFIN & SZIPL, PC, SUITE PH-1, 2300 NINTH STREET, SOUTH, ARLINGTON, VA, 22204, US

(73) Assignee: JAPAN HEALTH SCIENCES FOUNDATION, Tokyo (JP)

(21) Appl. No.: 11/997,221

(22) PCT Filed: Jul. 27, 2006
(86) PCT No.: PCT/JP2006/314868

§ 371 Date: Mar. 4, 2010

(30) Foreign Application Priority Data
Jul. 29, 2005 (JP) 2005-220352

(51) Int. Cl. G01T 1/161

(52) U.S. Cl. 250/394; 250/395

(57) ABSTRACT

The invention provides a tomograph, and a tomography method, that is capable of providing reconstructed images of high resolution without truncation for large subjects such as a human body.

The tomography 10 consists of first detecting unit 18 that is equipped with multiple radiation detectors, which are arranged in such a way that the view field centers of pinhole collimeters they own approximately match with each other, and is capable of moving around a subject 12 along first orbit C1, and a second detecting unit 22 that is equipped with a plurality of radiation detectors and is capable of moving around the subject 12 along a second orbit C2 that is placed further away from the subject 12 than the first orbit C1, and reconstructs images using image data obtained by the first detector 18 and the second detecting unit 22.

This is a National Phase Application in the United States of International Patent Application No. PCT/JP2006/314868 filed Jul. 27, 2006, which claims priority on Japanese Patent Application No. 2005-220352, filed Jul. 29, 2005. The entire disclosures of the above patent applications are hereby incorporated by reference.

### TECHNICAL FIELD OF THE INVENTION

The present invention relates to a tomograph represented by single photon emission computer tomograph (“SPECT”) and positron emission tomograph (“PET”).

### BACKGROUND ART

Single photon emission computer tomograph (“SPECT”) has been known as a tomograph that makes it possible to view images of the distributions of drugs tagged with radioactive isotopes that are administered into subject human bodies. A SPECT apparatus causes a collimeter mounted on the surface of a position detecting type radiation detector to rotate around the periphery of the subject to collect radiation data for the entire circumference, and analyzes the signal synchronized with the rotation to estimate the distribution of the radioactive drug inside the subject. A SPECT apparatus equipped with a pin-hole collimeter, which has a single hole as a collimeter, through which radiations from the subject is projected to the radiation detector as a cone beam pass through the hole, has advantages that its design constitution is simple, and can improve spatial resolution by taking pictures by approaching the subject by making the hole diameter smaller, so that it is suitably used for tomography of small animals such as rats, mice, etc.

On the other hand, in order to obtain the perfect image reconstruction in a SPECT apparatus equipped with a pinhole collimeter, the Tuy's condition (see: cited non-patent document 1) is proposed, which premise does not hold in a cross section other than the plane of rotation in the geometrical design of the conventional pinhole SPECT apparatus, so that such a design had shortcomings that it is impossible to measure radiation density accurately on a cross section that does not include the hole while the image on the plane of rotation that includes the hole can be accurately reconstructed at least theoretically; moreover, even the image on the plane of rotation including the hole may suffer an image distortion due to uneven resolution.

To the contrary, cited patent document 1 discloses a pinhole SPECT apparatus for detecting radiations not just on one plane of rotation including the center of the field of view but also radiations outside of the plane of rotation by having one or more position detecting type radiation detectors equipped with a pinhole collimeter to capture the subject always within the field of view, as well as by arranging detector positions, pinhole position offsets, cradling motion of the base, etc. According to the particular SPECT apparatus, it is possible to improve the resolution of the reconstructed images obtained by the image data since it is so constructed to cause the image data to satisfy the Tuy's condition by detecting radiations offset from the plane of rotation.

Moreover, the cited non-patent document 1 discloses a pinhole SPECT apparatus that causes the pinhole of the detector to rotate around the subject along two orbits, one at an angle of 90° and the other at 45° relative to the axis of the subject. According to this SPECT apparatus, the use of two pinhole orbits allows the image data to satisfy the Tuy's condition and makes it possible to obtain the perfect 3D pinhole SPECT reconstruction images in all view angles.

Patent document 1: JP-2004-233149A

Non-patent document 1: H. K. Tuy. An inversion formula for cone-beam reconstruction. SIAM J. APPL. MATH. Vol. 43, No. 3, 546-552 (1983)

Non-patent document 2: Tsutomu Zeniya, A new reconstruction strategy for image improvement in pinhole SPECT, European Journal of Nuclear Medicine and Molecular Imaging Vol. 31, No. 8, 1166-1172 (2004)

### PROBLEM TO BE SOLVED BY THE INVENTION

However, although such a tomograph of prior art allows to capture reconstructed image of high resolution in case of a small subject, such as a small animal, it has a problem that the truncation problem occurs when the subject is as large as a human body. Such a truncation problem can be avoided by making the orbit angle large enough relative to the subject, the resolution inherently deteriorates as the distance between the detector and the subject gets larger making it more difficult to obtain reconstructed images of high resolution so that it is difficult to achieve both the avoidance of truncation and the improvement of resolution simultaneously.

The present invention intends to solve such a problem and provide a tomograph capable of obtaining high resolution reconstructed images without truncation for large subjects such as human bodies.

### SUMMARY OF THE INVENTION

The abovementioned objective can be achieved by the tomograph, tomography and tomography program, and computer readable recording medium where the program is recorded according to the present invention.

The present invention is a tomograph comprising a first detecting unit that has one or more radiation detectors and is capable of moving around a subject along a first orbit, and a second detecting unit that has one or more radiation detectors and is capable of moving around the subject along a second orbit that is placed further away from the subject than the first orbit.

The present invention is also the tomograph described above further comprising an image reconstructing unit that reconstructs images using image data obtained from the first detecting unit and image data obtained from the second detecting unit.

The present invention is also the tomograph described above, wherein the first detecting unit conducts tomography by means of single photon emission computer tomography.

The present invention is also the tomograph described above, wherein the radiation detector of the first detecting unit is equipped with a pinhole collimeter.

The present invention is also the tomograph described above, wherein the second detecting unit conducts tomography by means of single photon emission computer tomography.

The present invention is also the tomograph described above, wherein the second detecting unit conducts tomography by means of positron emission computer tomography.

The present invention is also the tomograph described above, wherein a plane that includes the first orbit is different from a plane that includes the second orbit.

The present invention is also the tomograph described above, wherein a plane that includes the first orbit and a plane that includes the second orbit produce angles of 45° and 90° respectively relative to the axis of the subject.

The present invention is a tomography method comprising a first detecting step of detecting radiations by one or more radiation detectors moving around a subject along a first orbit, and a second detecting step of detecting radiations by one or more radiation detectors moving around the subject along a second orbit that is placed further away from the subject than the first orbit.

The present invention is also the tomography method described above further comprising an image reconstructing step of reconstructing images using image data obtained from the first detecting step and image data obtained from the second detecting step.

The present invention is also the tomography method described above, wherein the first detecting step conducts tomography by means of single photon emission computer tomography.

The present invention is also the tomography method described above, wherein the radiation detector used in the first detecting step is equipped with a pinhole collimeter.

The present invention is also the tomography method described above, wherein the second detecting step conducts tomography by means of single photon emission computer tomography.

The present invention is also the tomography method described above, wherein the second detecting step conducts tomography by means of positron emission computer tomography.

The present invention is also the tomography method described above, wherein a plane that includes the first orbit is different from a plane that includes the second orbit.

The present invention is also the tomography method described above, wherein a plane that includes the first orbit and a plane that includes the second orbit produce angles of 45° and 90° respectively relative to the axis of the subject.

The present invention is a tomography program that causes a computer to execute a first detecting step of detecting radiations by one or more radiation detectors moving around a subject along a first orbit, a second detecting step of detecting radiations by one or more radiation detectors moving around the subject along a second orbit that is placed further away from the subject than the first orbit, and an image reconstructing step of reconstructing images using image data obtained from the first detecting step and image data obtained from the second detecting step.

Further, the present invention is a computer readable recording medium where a tomography program described is recorded, wherein the tomography program causes a computer to execute: (a) a first detecting step of detecting radiations by one or more radiation detectors moving around a subject along a first orbit; (b) a second detecting step of detecting radiations by one or more radiation detectors moving around the subject along a second orbit that is placed further away from the subject than the first orbit; and (c) an image reconstructing step of reconstructing images using image data obtained from the first detecting step and image data obtained from the second detecting step.

### EFFECT OF THE INVENTION

The present invention enables one in tomography for large subjects such as a human body to obtain image data of a high spatial resolution from the first detector close to the subject and image data without truncation from the wide view second detector, thus producing reconstructed images of high resolution without truncation.

Also, it enables one to obtain perfect reconstructed images in all view angles since the plane that includes the first orbit is different from the plane that includes the second orbit thus causing the image data to satisfy the Tuy's condition.

### BRIEF DESCRIPTION OF DRAWINGS

The above and other objects, features and advantages of the present invention will become apparent from the following description and appended claims, taken in conjunction with the accompanying drawings.

FIG. 1 is an approximate side view of a tomograph according to the present invention.

FIG. 2 is an approximate front view of the tomograph.

FIG. 3 is an approximate perspective view showing only a characteristic part of the tomograph.

FIG. 4 is an approximate perspective view showing only a characteristic part of another tomograph according to the present invention.

### DETAILED DESCRIPTION OF THE INVENTION

The details of a tomograph according to an embodiment of the present invention will be described below using the accompanied drawings.

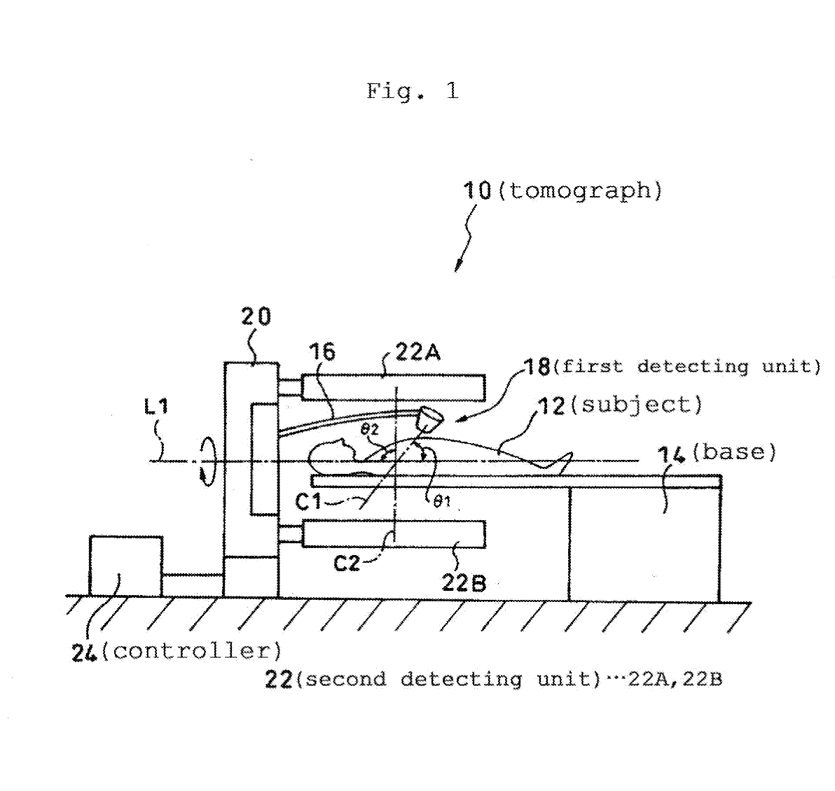

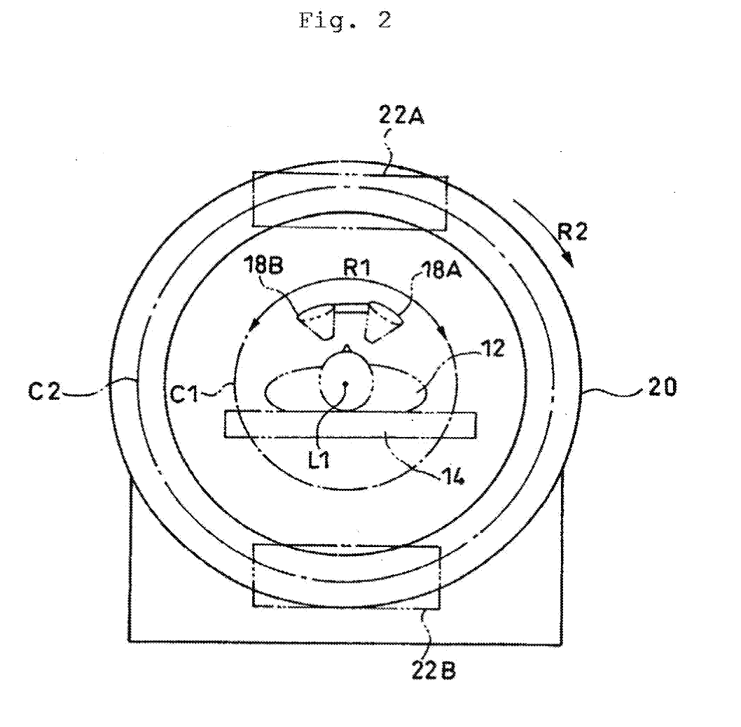

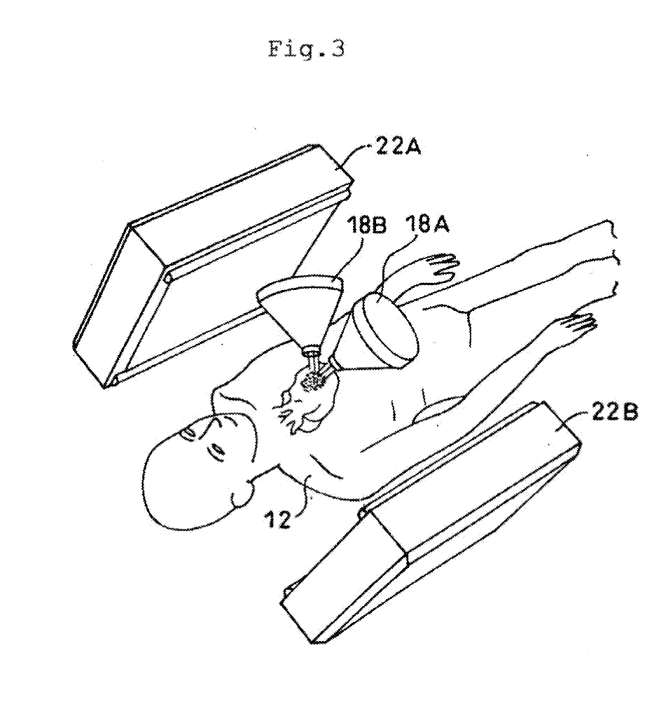

FIG. 1 is an approximate side view of a tomograph 10 according to an embodiment of the present invention, FIG. 2 is an approximate front view of tomograph 10, and FIG. 3 is an approximate perspective view showing only a characteristic part of the tomograph 10.

Tomograph 10 according to an embodiment of the present invention have a base 14 capable of supporting a subject 12 such as a patient, a first detecting unit 18 cantilever-supported by a swiveling device 16, a second detecting unit 22 cantilever-supported by a rotating device 20, and a controller 24.

The first detecting unit 18 consists of a plurality (two in the present embodiment) of gamma cameras for SPECT (“radiation detectors” according to the present invention) 18A an 18B arranged in such a way that their view field centers approximately match. Although it is preferable that the view field centers of these gamma cameras match in order to avoid complexity of the image reconstruction programming, it is not necessary that they match approximately.

Each of the gamma cameras 18A and 18B is equipped with conical pinhole collimeter, and is capable of detecting through the pinhole formed at the tip of the pinhole collimeter the two-dimensional incidence position of the radiation emitted from the nuclide (radio isotope: RI) injected into the subject 12.

The first detecting unit 18 is cantilever-supported by the arm-shaped swiveling device 16. This first detecting unit 18 is constituted in such a way as to be able to swivel (move) along a first orbit C1 established as an arc around the subject 12 with the axis L1 of the subject 12 (hereinafter called “subject axis L1”) as the axis within the range of arrow R1 (see FIG. 2) when a swiveling device 16 is driven.

The first orbit C1 along which the first detecting unit 18 moves is an orbit tilted at an angle θ1 (45° in the present embodiment) relative to the subject axis L1 as shown in FIG. 1.

While the first detecting unit 18 is constituted to swivel within the specified range in the present embodiment, “the first detecting unit” according to the present invention is not limited to it; for example, the first detecting unit 18 can be set up to move along the entire circumference of the first orbit C1, or the tilt angle θ1 of the first orbit C1 relative to the subject axis L1 can be arbitrarily set up.

In the meanwhile, the second detector 22 consists of a plurality (two in the present embodiment) of flat gamma cameras for SPECT (“radiation detectors” according to the present invention) 22A and 22B arranged in such a way that their view field centers approximately match.

The gamma cameras 22A and 22B are, similar to the abovementioned gamma cameras 18A and 18B, capable of detecting the two-dimensional incidence position of the radiation emitted from the nuclide (radio isotope: RI) injected into the subject 12.

The second detecting unit 22 is cantilever-supported by the disc-shaped rotating device 20. The second detecting unit 22 is constituted in such a way as to be able to move over the entire circumference of the subject 12 by driving the rotating device 20 in the direction of arrow R2 (see FIG. 2) along a circular orbit C2, which is placed further away from the subject 12 than the first orbit C1. The second orbit C2 along which the second detecting unit 22 moves is an orbit tilted at an angle θ2 (90° in the present embodiment) relative to the subject axis L1 as shown in FIG. 1. In other words, the second orbit C2 is tilted in such a way that the plane that includes the first orbit C1 is different from the plane that includes the second orbit C2.

Although the second detecting unit 22 in this embodiment is constituted in such a way as to be movable in the direction of R2 for the entire circumference of the subject 12, “the second detecting unit” according to the present invention is not limited to that, but rather the second detecting unit 22 can also be constituted to be movable along the second orbit C2 within a certain range and the tilt angle θ2 of the second orbit C2 relative to the subject axis L1 can be set to the same angle as the tilt angle θ1 of the first orbit C1 relative to the subject axis L1.

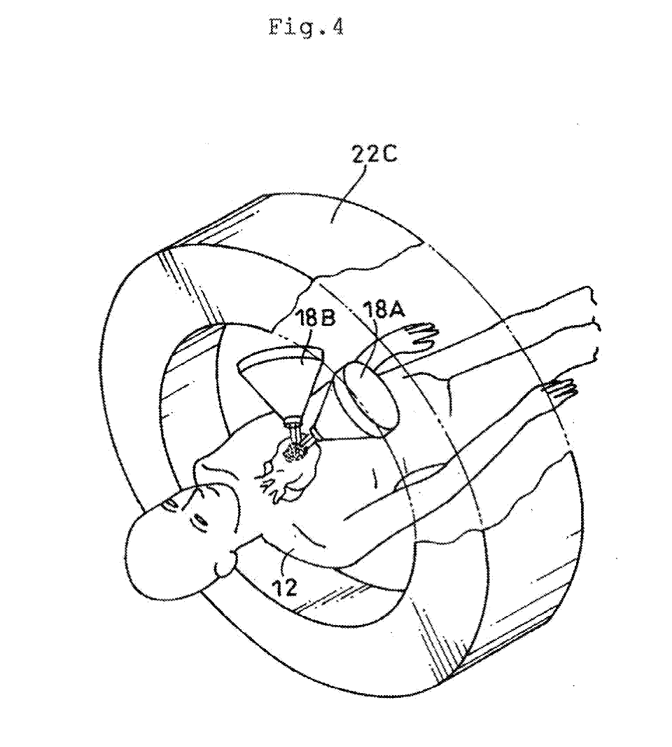

Moreover, the “second detector” according to the present invention is not limited to the detector for SPECT, and the gamma cameras 22A and 22B for SPECT can be substituted by a set (multiple pairs) of gamma camera 22C for PET as shown in FIG. 4.

The controller 24 consists of a controlling unit for controlling the motion of the first detecting unit 18 by the swiveling unit 16, controlling the motion of the second detecting unit 22 by the rotating device 20, an image reconstructing unit for reconstructing images based on a plurality of image data collected by the first detecting unit 18 and the second detecting unit 22, etc.

Next, the action of tomograph 10 according to the present embodiment will be described in detail below.

When the swiveling device 16 is driven by the controller 24, the first detecting unit 18 is swiveled along the first orbit C1 around the subject 12 within the range of the arrow R1 to collect the image data by detecting the radiation around the subject 12.

Also, when the rotating device 20 is driven by the controller 24, the second detecting unit 22 is moved along the second orbit C2 around the entire circumference of the subject 12 in the direction of the arrow R2 to collect the image data by detecting the radiation around the subject 12.

The controller 24 obtains a reconstructed image by reconstructing the CT image, which is a tomography image, based on high spatial resolution image data collected by the first detecting unit 18 and wide view image data collected by the second detecting unit 22.

While various publicly known methods, such as analytical methods including the direct Fourier reverse conversion method using Fourier conversion and others, the filter compensation backward projection method (FBP method), and the convolution back-projection method (CBP method), and algebraic methods such as the successive approximation method can be used for reconstructing images, the successive approximation method, which is shown below, is preferably used.

In other words, the particular image reconstruction method is a method for updating the image by successive approximation, and it is to estimate an image that maximizes the probability density function defined by the following formula:

$$P ( y ; λ ) = {\prod }_{i} \{ \begin{matrix}\frac{{( {\sum }_{j} {a}_{ij} {λ}_{j} )}^{yi}}{{y}_{i} !} exp \\ [ - {\sum }_{j} {a}_{ij} {λ}_{j} ]\end{matrix} \} \qquad [ Mathematical formula 1 ]$$

The calculation formula for actual successive approximation is as follows:

$${λ}_{j}^{( k + 1 )} = \frac{{λ}^{( k )}}{{\sum }_{j} {a}_{ij}} {\sum }_{i} \frac{{a}_{ij} {y}_{i}}{{\sum }_{n} {a}_{i n} {λ}_{n}^{( k )}} \qquad [ Mathematical formula 2 ]$$

where λ is the reconstructed image, λⱼ is the count value of the j-th pixel (position) in the image, while k and k+1 are k-th and k+1-st calculated images respectively. Also, y is measured data, i.e., projection data, and yᵢ is the count value of the data of the i-th pixel. Further, aᵢⱼ is a coefficient, which is a geometrically determined value the degree of contribution of the j-th pixel value of the i-th projection data. An image can be reconstructed by successively approximating images using the projection data y of two different resolutions, i.e., the high resolution image data collected by the first detecting unit 18 and the wide view image data collected by the second detecting unit 22.

Such an image reconstruction process enables one with the help of image data collected by the first detecting unit 18 to interpolate the image data that could not be collected due to the fact that the first detecting unit 18 is blocking the view of the second detecting unit 22 (the case where the first detecting unit 18 is located in a space inside of the second detecting unit 22).

As described above, the tomograph 10 according to the present embodiment consists of the first detecting unit 18 that is equipped with one or more radiation detectors (gamma cameras 18A and 18B in the present embodiment), which are arranged in such a way that the view field centers of pinhole collimeters they own approximately match with each other, and is capable of moving around the subject 12 along the first orbit C1, and the second detecting unit 22 that is equipped with a plurality of radiation detectors (gamma cameras 22A and 22B in the present embodiment) and is capable of moving around the subject 12 along the second orbit C2 that is placed further away from the subject 12 than the first orbit C1, so that the present invention enables one to use the image data of a high spatial resolution obtained by the first detector 18 placed close to the subject 12 and the image data without truncation obtained the wide view second detecting unit 22 to reconstruct images of high resolution without truncation.

In particular, it enables one to obtain perfect reconstructed images in all view angles since the plane that includes the first orbit C1 is different from the plane that includes the second orbit C2 thus causing the image data to satisfy the Tuy's condition.

The tomograph according to the present invention should not be construed to be limited to the embodiment described above, and it goes without saying that various modifications can be made within the scope of the gist of the invention.

The tomograph according to the present invention is especially suitable for tomography of large subjects such as a human body as it has an excellent effect of providing reconstructed images of high resolution without truncation even in case of large subjects.

The entire disclosure of Japanese Patent Application No. 2005-220352 filed on Jul. 29, 2007 including specification, claims, drawings, and summary are incorporated herein by reference in its entirety.

1. A tomograph comprising:
a first detecting unit that has one or more radiation detectors and is capable of moving around a subject along a first orbit; and
a second detecting unit that has one or more radiation detectors and is capable of moving around said subject along a second orbit that is placed further away from said subject than said first orbit.

2. The tomograph described in claim 1 further comprising:
an image reconstructing unit that reconstructs images using image data obtained from said first detecting unit and image data obtained from said second detecting unit.

3. The tomograph of either claim 1, wherein
said first detecting unit conducts tomography by means of single photon emission computer tomography.

4. The tomograph described in claim 3, wherein
the radiation detector of said first detecting unit is equipped with a pinhole collimeter.

5. The tomograph of claim 1, wherein
said second detecting unit conducts tomography by means of single photon emission computer tomography.

6. The tomograph of claim 1, wherein
said second detecting unit conducts tomography by means of positron emission computer tomography.

7. The tomograph of claim 1, wherein
a plane that includes said first orbit is different from a plane that includes said second orbit.

8. The tomograph described in claim 7, wherein
the plane that includes said first orbit and the plane that includes said second orbit produce angles of 45° and 90° respectively relative to an axis of the subject.

9. A tomography method comprising the steps of:
(a) detecting radiations by one or more radiation detectors moving around a subject along a first orbit; and
(b) detecting radiations by one or more radiation detectors moving around said subject along a second orbit that is placed further away from said subject than said first orbit.

10. The tomography method described in claim 9, further comprising the step of:
(c) reconstructing images using image data obtained from step (a) and image data obtained from step (b).

11. The tomography method of claim 9, wherein
step (a) conducts tomography by means of single photon emission computer tomography.

12. The tomography method described in claim 11, wherein
the radiation detector used in step (a) is equipped with a pinhole collimeter.

13. The tomography method of claim 9, wherein
step (b) conducts tomography by means of single photon emission computer tomography.

14. The tomography method of claim 9, wherein
step (b) conducts tomography by means of positron emission computer tomography.

15. The tomography method of claim 9, wherein
a plane that includes said first orbit is different from a plane that includes said second orbit.

16. The tomography method described in claim 15, wherein
the plane that includes said first orbit and the plane that includes said second orbit produce angles of 45° and 90° respectively relative to an axis of the subject.

17. A computer readable recording medium upon which a tomography program is recorded, wherein the tomography program causes a computer to execute the steps of:
(a) detecting radiations by one or more radiation detectors moving around a subject along a first orbit;
(b) detecting radiations by one or more radiation detectors moving around said subject along a second orbit that is placed further away from said subject than said first orbit; and
(c) reconstructing images using image data obtained from step (a) and image data obtained from step (b).

18. (canceled)

19. The tomograph of claim 2, wherein said first detecting unit conducts tomography by means of single photon emission computer tomography.

20. The tomography method of claim 10, wherein step (a) conducts tomography by means of single photon emission computer tomography.
